(19) United States
(12) Patent Application Publication
(10) Pub. No.: US 2018/0059234 A1
(43) Pub. Date: Mar. 1, 2018

(54) SYSTEMS, DEVICES, AND METHODS FOR MOTION DETECTION USING AN AIR CURTAIN

(71) Applicant: Wal-Mart Stores, Inc., Bentonville, AR (US)

(72) Inventors: Nicholaus Adam Jones, Fayetteville, AR (US); Robert James Taylor, Rogers, AR (US); Aaron James Vasgaard, Rogers, AR (US); Matthew Allen Jones, Bentonville, AR (US)

(73) Assignee: Wal-Mart Stores, Inc., Bentonville, AR (US)

(21) Appl. No.: 15/685,096

(22) Filed: Aug. 24, 2017

Related U.S. Application Data
(60) Provisional application No. 62/379,338, filed on Aug. 25, 2016.

(51) Int. Cl. G01S 13/56; G01S 7/41

(52) U.S. Cl. CPC G01S 13/56; G01S 7/412

(57) ABSTRACT

Methodologies, systems, and computer-readable media are provided for detection motion using an air curtain. An air flow source generates an air curtain that can rotate an airfoil located downstream of the air flow source. The airfoil contains an RF reflective material, and a sensor can detect RF reflections from the airfoil. The sensor communicates data associated with the RF energy reflections detected from the airfoil to a computing device that can compare this data against a reflection threshold value. The computing device can determine whether an object has obstructed the air curtain if the reflections detected by the sensor decrease below the reflection threshold value. The computing device can also compute a number of objects passing through the air curtain during a specified period of time.

### RELATED APPLICATIONS

This application claims priority to U.S. Provisional Patent Application Ser. No. 62/379,338 entitled “SYSTEMS, DEVICES, AND METHODS FOR MOTION DETECTION USING AN AIR CURTAIN,” filed on Aug. 25, 2016, the contents of which is hereby incorporated by reference in its entirety.

### BACKGROUND

Air “curtains” are generated by projecting flows of air at a designated location. One use of air curtains is to create a temperature differential at an opening to a building and thus limit the flow of air out of or into the building.

### SUMMARY

Embodiments of the present invention utilize an air curtain, a radio frequency (RF) sensor, and an RF reflective airfoil to facilitate motion detection. For example, embodiments may include an air flow source that generates an air curtain, and the air curtain can rotate the RF reflective airfoil. An RF sensor can detect an amount of RF energy reflected by the rotating airfoil. By monitoring changes in the amount of RF energy reflected by the airfoil, the system can determine changes in the speed of rotation of the airfoil. These changes in the speed of rotation of the airfoil can be interpreted as indicative of an object passing through the air curtain.

In one embodiment, a system for detecting motion includes an air flow source configured to generate an air curtain. The system also includes a rotatable airfoil located at least partially downstream of the air flow source and containing an RF reflective material. The air curtain causes the airfoil to rotate. The system also includes a sensor configured to detect RF reflections from the airfoil. The sensor includes a communication interface configured to transmit data associated with the detected reflections. The system also includes a computing device equipped with a processor and configured to receive the transmitted data from the sensor. The computing device also is configured to execute a reflection analysis module that compares reflections detected by the sensor against a reflection threshold value. The reflection analysis module also determines that an object has obstructed the air curtain in response to reflections detected by the sensor decreasing below the reflection threshold value. The reflection analysis module additionally computes a number of objects passing through the air curtain during a specified period of time in response to reflections detected by the sensor decreasing below the reflection threshold value and compares the number computed against traffic data collected from a computing terminal.

In another embodiment, a method for motion detection includes generating an air curtain via an air flow source and rotating a rotatable airfoil located at least partially downstream of the air flow source. The rotatable airfoil includes an RF reflective material. The method also includes detecting RF reflections from the airfoil using a sensor and comparing reflections detected by the sensor against a reflection threshold value. The method further includes determining that an object has obstructed the air curtain in response to reflections detected by the sensor decreasing below the reflection threshold value. The method additionally includes computing a number of objects passing through the air curtain during a specified period of time in response to reflections detected by the sensor decreasing below the reflection threshold value. The method also includes comparing the number of computed objects against traffic data collected from a computing terminal.

Additional combinations and/or permutations of the above examples are envisioned as being within the scope of the present disclosure. It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method of motion detection, in accordance with an exemplary embodiment of the present invention.

FIG. 2 is a flowchart illustrating another exemplary method of motion detection, in accordance with an exemplary embodiment of the present invention.

FIG. 3 is a flowchart illustrating another exemplary method of motion detection, in accordance with an exemplary embodiment of the present invention.

FIG. 4 is a flowchart illustrating another exemplary method of motion detection, in accordance with an exemplary embodiment of the present invention.

FIG. 5 is a diagram of an exemplary network environment suitable for a distributed implementation of an exemplary embodiment of the present disclosure.

FIG. 6 is a block diagram of an exemplary computing device that can be used to perform exemplary processes in accordance with an exemplary embodiment of the present disclosure.

### DETAILED DESCRIPTION

Following below are more detailed descriptions of various concepts related to, and embodiments of, inventive methods, apparatus, and systems for detecting motion using an air curtain. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

In accordance with some embodiments of the present invention, methodologies, systems, apparatus, and non-transitory computer-readable media are described herein to facilitate detecting motion using an air curtain. In exemplary embodiments, an air flow source can generate an air curtain across a doorway or entrance to a building. The air curtain can limit the amount of air that can pass through the doorway and help maintain a constant temperature within the building. The air curtain can also rotate a rotatable airfoil that is located downstream of the air flow source. In some embodiments, one or more airfoils can be located near a doorway downstream of the air flow source or on the side of a sliding door. The airfoil can include an RF reflective material that can reflect specific amounts of RF energy while rotating at specific speeds. If a person or object passes through the air curtain, the disruption of the air curtain changes the amount of air flowing across the doorway and also change the speed of rotation of the airfoil. Because the reflective airfoil reflects different amounts of RF energy at different speeds, an RF sensor can detect when objects pass through the air curtain by detecting changes in the amount of RF energy reflected by the rotating airfoil. In one embodiment, an amount of RF energy is directed toward the reflective airfoil and an RF sensor measures the amount of energy reflected by the airfoil.

In some embodiments, a change in energy reflections detected from the reflective airfoil can indicate that an object has passed through the air curtain. For example, the amount of reflected RF energy detected from a reflective airfoil can be compared against a threshold value in order to determine whether a person has passed through the air curtain. The threshold value can be based on the reflectivity of the airfoil while it is rotating under the impulse of an unobstructed air curtain and the expected change in reflection caused by a person passing through the air curtain. The threshold value can be adjusted, in some embodiments, in order to tune the sensitivity of the motion detection system to detect larger or smaller objects passing through the air curtain.

In some embodiments, a motion detection system can monitor reflections from the airfoil for a specific period of time and compute the number of persons passing through the air curtain during that period of time based on changes in reflections from the airfoil. In one such embodiment, a motion detection system, as described herein, is located at each entrance to an enterprise and customer traffic data collected from the motion detection systems can be compared against customer traffic data collected from point of sale (POS) terminals within the enterprise.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

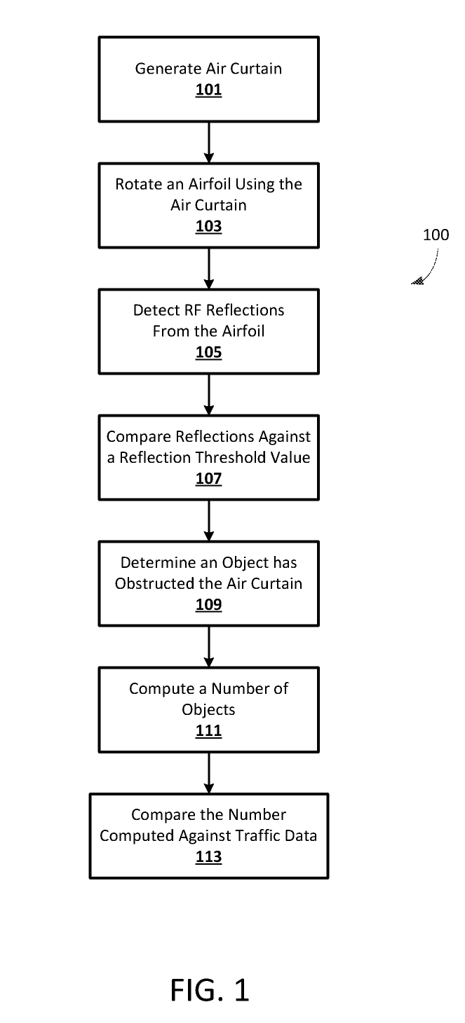

In one embodiment, the motion detection system described herein can detect the number of objects passing through the air curtain during a specified time period. FIG. 1 is a flowchart illustrating an exemplary method 100 for motion detection. It will be appreciated that the method is programmatically performed by one or more computer-executable processes executing on, or in communication with one or more servers described further below. In step 101, an air flow source generates an air curtain. As described herein, an air curtain is a flow of air across a doorway or other open space. The flow of air, or air curtain, can substantially limit the amount of air or other small objects that can pass through the doorway or open space. The air curtain can also help maintain a temperature difference and reduce heat transfer between the air on opposing sides of the air curtain.

In step 103, a rotatable airfoil is rotated by the air curtain. The rotatable airfoil is located at least partially downstream of the air flow source, and the airfoil contains an RF reflective material. In some embodiments, an exterior portion of the rotatable airfoil is covered with an RF reflective material, an RF reflective paint, or an RF reflective tape. In other embodiments, the airfoil itself is made of an RF reflective material. Examples of RF reflective materials include reflective metallic foil, reflective metallic threading, reflective micro-glass beads, or any other suitable reflective material. In some embodiments, a plurality of airfoils can be located at various entrances to a building or structure, and each entrance can be equipped with its own air flow source for generating an air curtain across the entrance.

In step 105, a sensor detects RF energy reflections from the rotatable airfoil. The sensor also includes a communication interface that can transmit data associated with the detected reflections to a computing device. In some embodiments, an RF transmitter can direct RF energy toward the airfoil, and the sensor can detect the amount of RF energy reflected by the airfoil. In some embodiments, the sensor is configured to continuously scan for RF energy reflected from the airfoil. The rotatable airfoil reflects a specific amount of RF energy when rotating at a specific speed, and any changes in the speed of rotation of the airfoil can result in a change in the amount of RF energy reflected and detected at the sensor. Thus, by monitoring the amount of RF energy reflected by the rotating airfoil, the system can effectively monitor the speed of rotation of the airfoil and thus monitor whether the flow of air in the air curtain has been disrupted.

In step 107, a reflection analysis module of the computing device compares the reflections detected by the sensor against a reflection threshold value. The reflection threshold value can be determined, in some embodiments, based on a reflectivity of the airfoil while the air curtain is substantially unobstructed and the amount of change in reflectivity caused by an object passing through the air curtain. When the air curtain is substantially unobstructed, the airfoil rotates at a specific speed. While rotating at this speed, the airfoil has a specific reflectivity and reflects a specific amount of RF energy. If the amount of detected RF energy reflected decreases, this can indicate that something has obstructed the air curtain and caused a change in the speed of rotation of the airfoil. The amount of change in RF energy reflected can thus indicate the size of an object passing through the air curtain. The reflection threshold value can be set, in some embodiments, in order to detect objects of a certain size, such as the size of an average person, passing through the air curtain.

In step 109, the reflection analysis module determines that an object has obstructed the air curtain in response to reflections detected by the sensor decreasing below the reflection threshold value. As discussed above, the amount of change in RF energy reflected by the airfoil can indicate the size of objects passing through the air curtain. In some embodiments, the reflection threshold value can set the sensitivity of the motion detection system. For example, in order to detect whether a person has passed through the air curtain, the reflection threshold value can be set such that objects smaller than an average person do not cause the reflections detected by the sensor to fall below the reflection threshold value.

In step 111, the reflection analysis module computes the number of objects passing through the air curtain during a specified period of time in response to the reflections detected by the sensor decreasing below the reflection threshold value. In some embodiments, the reflection threshold value can be set to detect objects passing through the air curtain that are equal to or greater in size than an average person. In such an example, the reflection analysis module can compute the number of people passing through the air curtain in a specified period of time.

In step 113, the reflection analysis module executed by the computing device compares the number of objects passing through the air curtain that were computed in step 111 against traffic data collected from a computing terminal. In some embodiments, the computing terminal can be a POS terminal within an enterprise, and the POS terminal can monitor customer traffic within the enterprise. In one embodiment, a motion detection system, as disclosed herein, is placed at each entrance to an enterprise and the customer traffic data collected by the motion detection system can be compared against traffic data collected from the POS terminals within the enterprise. In some embodiments, if the customer traffic data collected by the motion detection system is significantly different from the customer traffic data collected from the POS terminals, this may indicate the need to adjust the reflection threshold value of the motion detection system. Alternatively, in another embodiment, if the customer traffic data collected by the motion detection system is significantly different from the customer traffic data collected from the POS terminals, this may provide valuable information regarding how many customers are entering the enterprise without purchasing anything.

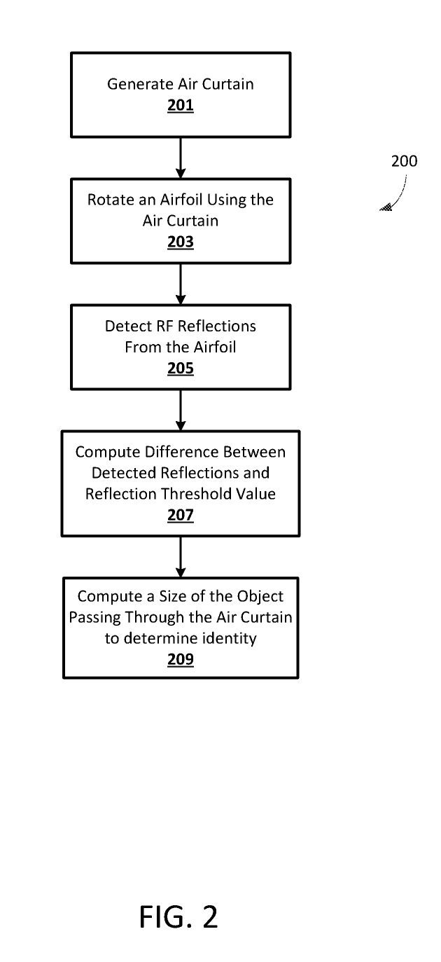

In one embodiment, the motion detection system can detect the size of objects passing through the air curtain and thus identify them. FIG. 2 is a flowchart illustrating another exemplary method 200 for motion detection. It will be appreciated that the method is programmatically performed by one or more computer-executable processes executing on, or in communication with one or more servers described further below. In step 201, an air flow source generates an air curtain. As described herein, an air curtain is a flow of air across a doorway or other open space that can substantially limit the amount of air that can pass through the doorway or open space. The air curtain can also help maintain a temperature difference and reduce heat transfer between the air on opposing sides of the air curtain, in some embodiments.

In step 203, a rotatable airfoil is rotated by the air curtain. The rotatable airfoil is located at least partially downstream of the air flow source, and the airfoil contains an RF reflective material. In some embodiments, an exterior portion of the rotatable airfoil is covered with an RF reflective material, an RF reflective paint, or an RF reflective tape. In other embodiments, the airfoil itself is made of an RF reflective material. Examples of RF reflective materials include reflective metallic foil, reflective metallic threading, reflective micro-glass beads, or any other suitable reflective material. In some embodiments, a plurality of airfoils can be located at various entrances to a building or structure, and each entrance can be equipped with its own air flow source for generating an air curtain across the entrance.

In step 205, a sensor detects RF energy reflections from the rotatable airfoil. The sensor also includes a communication interface that can transmit data associated with the detected reflections to a computing device. In some embodiments, an RF transmitter can direct RF energy toward the airfoil, and the sensor can detect the amount of RF energy reflected by the airfoil. In some embodiments, the sensor is configured to continuously scan for RF energy reflected from the airfoil. The rotatable airfoil reflects a specific amount of RF energy when rotating at a specific speed, and any changes in the speed of rotation of the airfoil can result in a change in the amount of RF energy reflected and detected at the sensor. Thus, by monitoring the amount of RF energy reflected by the rotating airfoil, the system can effectively monitor the speed of rotation of the airfoil and thus monitor whether the flow of air in the air curtain has been disrupted.

In step 207, a reflection analysis module of the computing device computes a difference between the reflections detected by the sensor and a reflection threshold value. The reflection threshold value can be determined, in some embodiments, based on a reflectivity of the airfoil while the air curtain is substantially unobstructed and the amount of change in reflectivity caused by an object passing through the air curtain. When the air curtain is substantially unobstructed, the airfoil rotates at a specific speed. While rotating at this speed, the airfoil has a specific reflectivity and reflects a specific amount of RF energy. If the amount of detected RF energy reflected decreases, this can indicate that something has obstructed the air curtain and caused a change in the speed of rotation of the airfoil. The amount of change in RF energy reflected, or the difference between the detected reflections and the reflection threshold value, can thus indicate the size of an object passing through the air curtain. The reflection threshold value can be set, in some embodiments, in order to detect objects of a certain size, such as the size of an average person, passing through the air curtain.

In step 209, the reflection analysis module computes a size or identity of the object passing through the air curtain. In some embodiments, the difference between the reflections detected from the rotating airfoil and the reflection threshold value can indicate the size of an object passing through the air curtain. For example, an average person causes a specific change in air flow while passing through the air curtain, thus changing the speed of rotation of the airfoil and the amount of RF energy reflected by the airfoil in a specific way. If a larger object passes through the air curtain, the sensor detects a larger change in reflected energy and may be able to identify that a person with a shopping cart has passed through the air curtain. In another example, if the sensor detects a smaller change in reflected energy, the system may be able to identify that a child has passed through the air curtain or that a draught has altered the speed of rotation of the airfoil.

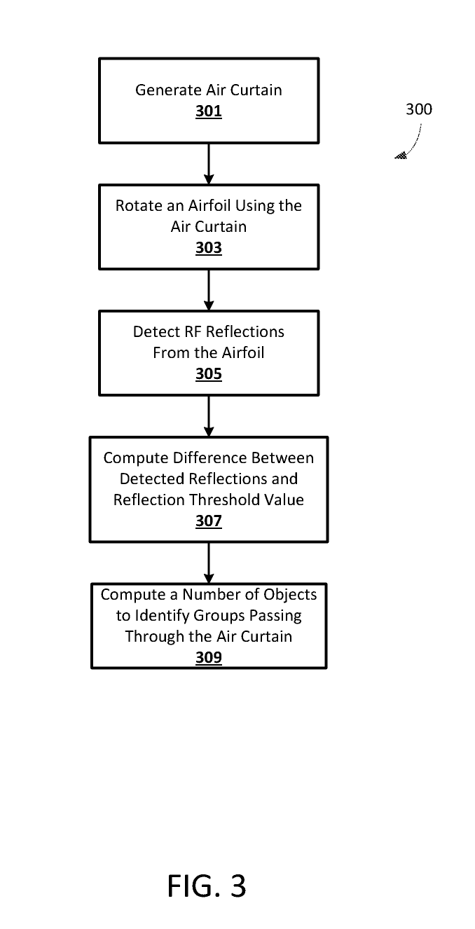

In one embodiment the motion detection system can detect groups of people passing through the air curtain. FIG. 3 is a flowchart illustrating another exemplary method 300 for motion detection. It will be appreciated that the method is programmatically performed by one or more computer-executable processes executing on, or in communication with one or more servers described further below. In step 301, an air flow source generates an air curtain. As described herein, an air curtain is a flow of air across a doorway or other open space that can substantially limit the amount of air that can pass through the doorway or open space. The air curtain can also help maintain a temperature difference and reduce heat transfer between the air on opposing sides of the air curtain, in some embodiments.

In step 303, a rotatable airfoil is rotated by the air curtain. The rotatable airfoil is located at least partially downstream of the air flow source, and the airfoil contains an RF reflective material. In some embodiments, an exterior portion of the rotatable airfoil is covered with an RF reflective material, an RF reflective paint, or an RF reflective tape. In other embodiments, the airfoil itself is made of an RF reflective material. Examples of RF reflective materials include reflective metallic foil, reflective metallic threading, reflective micro-glass beads, or any other suitable reflective material. In some embodiments, a plurality of airfoils can be located at various entrances to a building or structure, and each entrance can be equipped with its own air flow source for generating an air curtain across the entrance.

In step 305, a sensor detects RF energy reflections from the rotatable airfoil. The sensor also includes a communication interface that can transmit data associated with the detected reflections to a computing device. In some embodiments, an RF transmitter can direct RF energy toward the airfoil, and the sensor can detect the amount of RF energy reflected by the airfoil. In some embodiments, the sensor is configured to continuously scan for RF energy reflected from the airfoil. The rotatable airfoil reflects a specific amount of RF energy when rotating at a specific speed, and any changes in the speed of rotation of the airfoil can result in a change in the amount of RF energy reflected and detected at the sensor. Thus, by monitoring the amount of RF energy reflected by the rotating airfoil, the system can effectively monitor the speed of rotation of the airfoil and thus monitor whether the flow of air in the air curtain has been disrupted.

In step 307, a reflection analysis module of the computing device computes a difference between the reflections detected by the sensor and a reflection threshold value. The reflection threshold value can be determined, in some embodiments, based on a reflectivity of the airfoil while the air curtain is substantially unobstructed and the amount of change in reflectivity caused by an object passing through the air curtain. When the air curtain is substantially unobstructed, the airfoil rotates at a specific speed. While rotating at this speed, the airfoil has a specific reflectivity and reflects a specific amount of RF energy. If the detected amount of RF energy reflected decreases, this can indicate that something has obstructed the air curtain and caused a change in the speed of rotation of the airfoil. The amount of change in RF energy reflected, or the difference between the detected reflections and the reflection threshold value, can thus indicate the size or number of objects passing through the air curtain. The reflection threshold value can be set, in some embodiments, in order to detect objects of a certain size, such as the size of an average person, passing through the air curtain.

In step 309, the reflection analysis module computes a number of objects passing through the air curtain in a short period of time to identify groups of people. In some embodiments, the difference between the reflections detected from the rotating airfoil and the reflection threshold value can indicate the number of objects passing through the air curtain. For example, groups of people cause a specific change in air flow while passing through the air curtain, thus changing the speed of rotation of the airfoil and the amount of RF energy reflected by the airfoil in a specific way. If a group of five people passes through the air curtain, or if a steady stream of people pass through the air curtain for a specified period of time, the sensor detects a larger change in reflected energy and may be able to compute the number of persons passing through the air curtain.

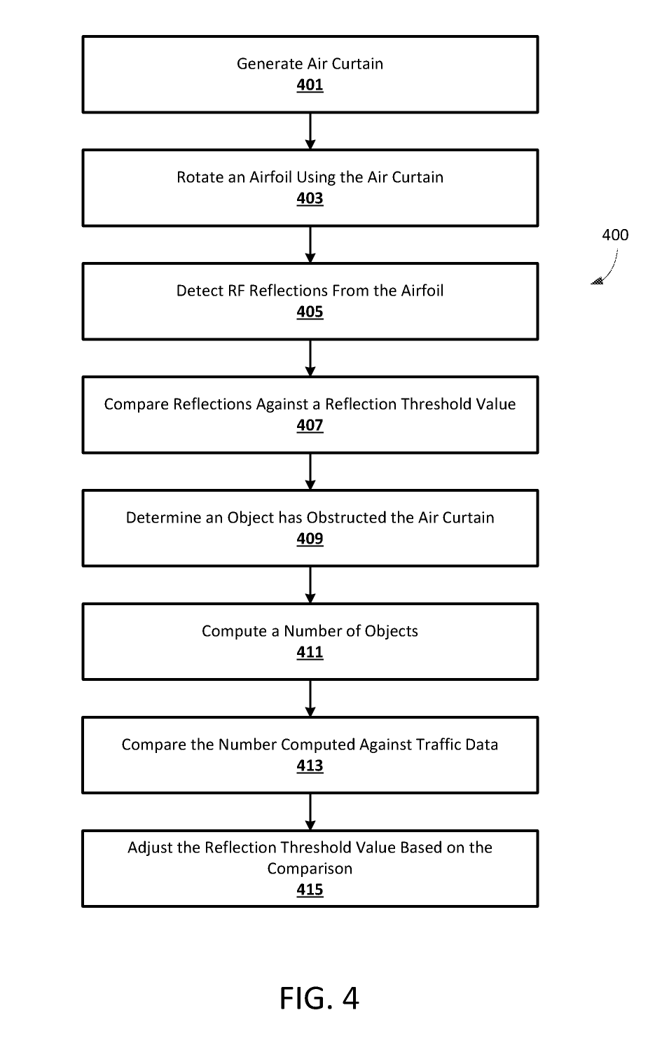

In one embodiment, the motion detection system may self-adjust its threshold values. FIG. 4 is a flowchart illustrating another exemplary method 400 for motion detection. It will be appreciated that the method is programmatically performed by one or more computer-executable processes executing on, or in communication with one or more servers described further below. In step 401, an air flow source generates an air curtain. As described herein, an air curtain is a flow of air across a doorway or other open space. The flow of air, or air curtain, can substantially limit the amount of air or other small objects that can pass through the doorway or open space. The air curtain can also help maintain a temperature difference and reduce heat transfer between the air on opposing sides of the air curtain.

In step 403, a rotatable airfoil is rotated by the air curtain. The rotatable airfoil is located at least partially downstream of the air flow source, and the airfoil contains an RF reflective material. In some embodiments, an exterior portion of the rotatable airfoil is covered with an RF reflective material, an RF reflective paint, or an RF reflective tape. In other embodiments, the airfoil itself is made of an RF reflective material. Examples of RF reflective materials include reflective metallic foil, reflective metallic threading, reflective micro-glass beads, or any other suitable reflective material. In some embodiments, a plurality of airfoils can be located at various entrances to an enterprise, and each entrance can be equipped with its own air flow source for generating an air curtain across the entrance.

In step 405, a sensor detects RF energy reflections from the rotatable airfoil. The sensor also includes a communication interface that can transmit data associated with the detected reflections to a computing device. In some embodiments, an RF transmitter can direct RF energy toward the airfoil, and the sensor can detect the amount of RF energy reflected by the airfoil. In some embodiments, the sensor is configured to continuously scan for RF energy reflected from the airfoil. The rotatable airfoil reflects a specific amount of RF energy when rotating at a specific speed, and any changes in the speed of rotation of the airfoil can result in a change in the amount of RF energy reflected and detected at the sensor. Thus, by monitoring the amount of RF energy reflected by the rotating airfoil, the system can effectively monitor the speed of rotation of the airfoil and thus monitor whether the flow of air in the air curtain has been disrupted.

In step 407, a reflection analysis module of the computing device compares the reflections detected by the sensor against a reflection threshold value. The reflection threshold value can be determined, in some embodiments, based on a reflectivity of the airfoil while the air curtain is substantially unobstructed and the amount of change in reflectivity caused by an object passing through the air curtain. When the air curtain is substantially unobstructed, the airfoil rotates at a specific speed. While rotating at this speed, the airfoil has a specific reflectivity and reflects a specific amount of RF energy. If the amount of detected RF energy reflected decreases, this can indicate that something has obstructed the air curtain and caused a change in the speed of rotation of the airfoil. The amount of change in RF energy reflected can thus indicate the size of an object passing through the air curtain. The reflection threshold value can be set, in some embodiments, in order to detect objects of a certain size, such as the size of an average person, passing through the air curtain.

In step 409, the reflection analysis module determines that an object has obstructed the air curtain in response to reflections detected by the sensor decreasing below the reflection threshold value. As discussed above, the amount of change in RF energy reflected by the airfoil can indicate the size of objects passing through the air curtain. In some embodiments, the reflection threshold value can set the sensitivity of the motion detection system. For example, in order to detect whether a person has passed through the air curtain, the reflection threshold value can be set such that objects smaller than an average person do not cause the reflections detected by the sensor to fall below the reflection threshold value.

In step 411, the reflection analysis module computes a number of objects passing through the air curtain during a specified period of time in response to the reflections detected by the sensor decreasing below the reflection threshold value. In some embodiments, the reflection threshold value can be set to detect objects passing through the air curtain that are equal to or greater in size than an average person. In such an example, the reflection analysis module can compute the number of people passing through the air curtain in a specified period of time.

In step 413, the reflection analysis module compares the number computed in step 411 against traffic data collected from a computing terminal. In some embodiments, the computing terminal can be a POS terminal within an enterprise, and the POS terminal can monitor customer traffic within the enterprise. In one embodiment, a motion detection system, as disclosed herein, is placed at each entrance to an enterprise, and the customer traffic data collected by the motion detection system can be compared against traffic data collected from the POS terminals within the enterprise. If the customer traffic data collected by the motion detection system is significantly different from the customer traffic data collected from the POS terminals, this may indicate the need to adjust the reflection threshold value of the motion detection system.

In step 415, the reflection threshold value is adjusted based on the comparison performed in step 413. In one example, if the customer traffic data collected by the motion detection system is significantly higher than the customer traffic data collected from the POS terminals, this may indicate that the motion detection system is too sensitive and is detecting customers passing through the air curtain when they do not exist. In such an example, adjusting the reflection threshold value can tune the sensitivity of the motion detection system to more accurately track customer traffic.

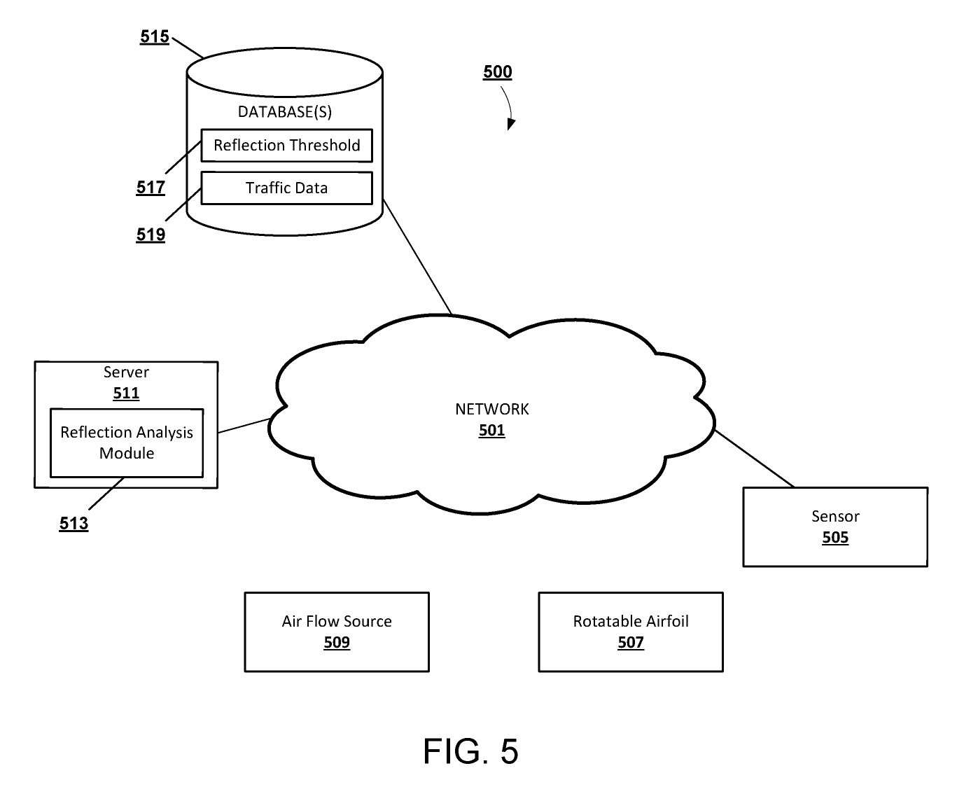

FIG. 5 illustrates a network diagram depicting a system 500 suitable for a distributed implementation of exemplary embodiments. The system 500 can include a network 501, sensor 505, rotatable airfoil 507, air flow source 509, server 511, and a database 515. As will be appreciated, various distributed or centralized configurations may be implemented. In exemplary embodiments, server 511 can store a reflection analysis module 513, which can implement one or more of the processes described herein with reference to FIGS. 1-4, or portions thereof. It will be appreciated that the module functionality may be implemented as a greater or lesser number of modules than illustrated and that the same server could also host multiple modules. The database 515 can store the restriction threshold values 517, as well as traffic data 519, in exemplary embodiments.

In exemplary embodiments, the air flow source 509 can generate an air curtain, as discussed above, and can cause the rotatable airfoil 507 to rotate. For example, the air flow source 509 may be a fan, a cooling unit or a heater configured to project a flow of air. The rotatable airfoil 507 includes a reflective material that can reflect an amount of RF radiation, which can be detected by the sensor 505. The sensor 505 can detect an amount of reflection produced by the rotatable airfoil 507, and the amount of reflection can vary depending on the speed of rotation of the rotatable airfoil 507. The sensor 505 can communicate with the server 511 to transmit detected reflection data over the network 501, in some embodiments. In one embodiment, the sensor 505 may be accompanied by an RF transmitter that projects RF energy towards the rotating airfoil.

The server 511 may connect to the network 501 via a wired or wireless connection. The server 511 may include one or more applications such as, but not limited to, a web browser, a sales transaction application, an object reader application, and the like.

In exemplary embodiments sensor 505, server 511, and database 515 may be in communication with each other via the network 501. The communication network 501 may include, but is not limited to, the Internet, an intranet, a LAN (Local Area Network), a WAN (Wide Area Network), a MAN (Metropolitan Area Network), a wireless network, an optical network, and the like. In one embodiment, sensor, 505, server 511, and database 515 can transmit instructions to each other over the communication network 501. In exemplary embodiments, the reflection threshold values 517 and the traffic data 519 can be stored at the database 515 and received at the server 511 in response to a service performed by a database retrieval application.

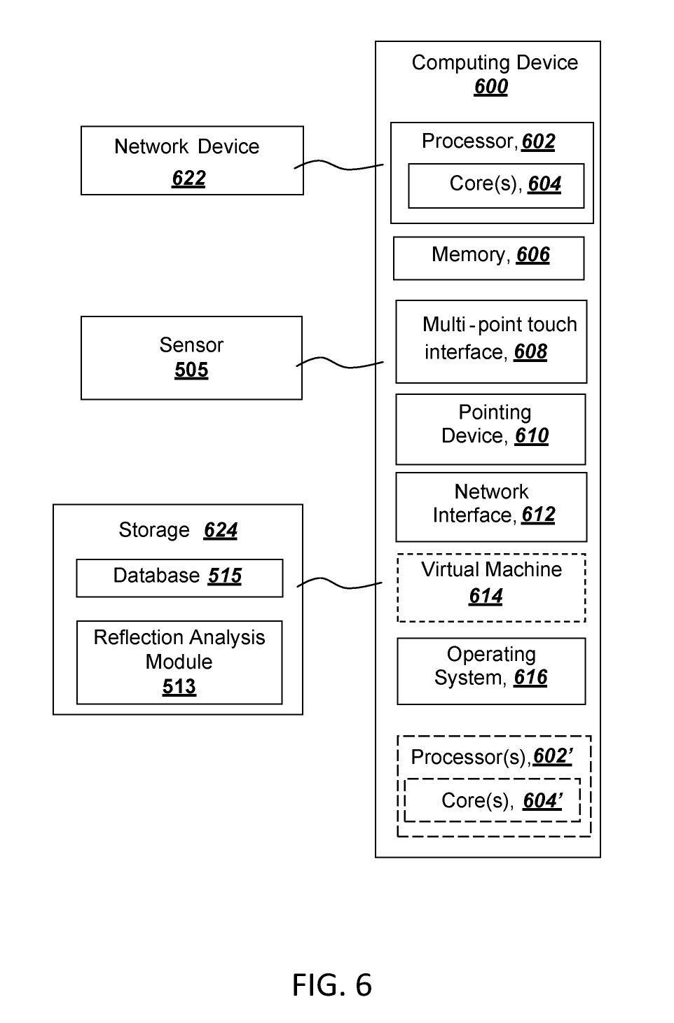

FIG. 6 is a block diagram of an exemplary computing device 600 that can be used in the performance of any of the example methods according to the principles described herein. The computing device 600 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 606 included in the computing device 600 can store computer-readable and computer-executable instructions or software for implementing exemplary embodiments and programmed to perform processes described above in reference to FIGS. 1-4. The computing device 600 also includes a processor 602 and an associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can be non-transitory computer-readable media including a computer system memory or random access memory, such as DRAM, SRAM, EDO RAM, and the like. Memory 606 can include other types of memory as well, or combinations thereof.

A user can interact with the computing device 600 through a display unit, such as a touch screen display or computer monitor, which can display one or more user interfaces that can be provided in accordance with exemplary embodiments. The computing device 600 can also include other I/O devices for receiving input from a user, for example, a keyboard or any suitable multi-point touch interface 608, a pointing device 610 (e.g., a pen, stylus, mouse, or trackpad). The multi-point touch interface 608 and the pointing device 610 can be coupled to the display unit. The computing device 600 can include other suitable conventional I/O peripherals.

The computing device 600 can also include one or more storage devices 624, such as a hard-drive, CD-ROM, or other non-transitory computer readable media, for storing data and computer-readable instructions and/or software, such as a reflection analysis module 513, that can implement exemplary embodiments of the methods and systems as taught herein, or portions thereof. Exemplary storage device 624 can also store one or more databases 515 for storing any suitable information required to implement exemplary embodiments. The database 515 can be updated by a user or automatically at any suitable time to add, delete, or update one or more items in the database 515. Exemplary storage device 624 can store one or more databases 515 for storing the reflection threshold values 517, traffic data 519, and any other data/information used to implement exemplary embodiments of the systems and methods described herein.

In some embodiments, the computing device 600 can be in communication with a sensor 505 that is capable of detecting RF reflections from a rotatable airfoil 507, as described above. The rotatable airfoil 507 can include a reflective material configured to reflect an amount of RF radiation, which can be detected by the sensor 505.

The computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run any operating system 616, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 616 can be run in native mode or emulated mode. In an exemplary embodiment, the operating system 616 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with a number of elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A motion detection system comprising:
an air flow source configured to generate an air curtain;
a rotatable airfoil located at least partially downstream of the air flow source and containing an RF reflective material, wherein the air curtain causes the airfoil to rotate;
a sensor configured to detect RF reflections from the airfoil, the sensor further including a communication interface configured to transmit data associated with the detected reflections; and
a computing device equipped with a processor, the computing device configured to receive the transmitted data from the sensor and execute a reflection analysis module, wherein the reflection analysis module is configured to:
compare reflections detected by the sensor against a reflection threshold value;
determine that an object has obstructed the air curtain in response to reflections detected by the sensor decreasing below the reflection threshold value;
compute a number of objects passing through the air curtain during a specified period of time in response to reflections detected by the sensor decreasing below the reflection threshold value; and
compare the number computed against traffic data collected from a computing terminal.

2. The system of claim 1, further comprising:
a plurality of rotatable airfoils located at an entrance to a building.

3. The system of claim 1, wherein the analysis module is further configured to compute a size of the object obstructing the air curtain based on a magnitude of difference between reflections detected by the sensor and the reflection threshold value.

4. The system of claim 1, wherein the analysis module is further configured to compute a number of objects obstructing the air curtain based on a magnitude of difference between reflections detected by the sensor and the reflection threshold value.

5. The system of claim 1, wherein the sensor is configured to continuously scan for RF energy reflected from the airfoil.

6. The system of claim 1, wherein the analysis module is further configured to adjust the reflection threshold value based on the comparison.

7. The system of claim 1, wherein the analysis module is further configured to determine an identity of the object obstructing the air curtain based on a magnitude of difference between reflections detected by the sensor and the reflection threshold value.

8. A method for motion detection, the method comprising:
generating an air curtain via an air flow source;
rotating a rotatable airfoil located at least partially downstream of the air flow source, wherein the airfoil contains an RF reflective material;
detecting RF reflections from the airfoil using a sensor;
comparing reflections detected by the sensor against a reflection threshold value;
determining that an object has obstructed the air curtain in response to reflections detected by the sensor decreasing below the reflection threshold value;
computing a number of objects passing through the air curtain during a specified period of time in response to reflections detected by the sensor decreasing below the reflection threshold value; and
comparing the number computed against traffic data collected from a computing terminal.

9. The method of claim 8, wherein detecting RF reflections includes detecting RF reflections from a plurality of airfoils located at an entrance to a building.

10. The method of claim 8, further comprising:
computing a size of the object obstructing the air curtain based on a magnitude of difference between reflections detected by the sensor and the reflection threshold value.

11. The method of claim 8, further comprising:
computing a number of objects obstructing the air curtain based on a magnitude of difference between reflections detected by the sensor and the reflection threshold value.

12. The method of claim 8, further comprising continuously scanning, via the sensor, for RF energy reflected from the airfoil.

13. The method of claim 8, further comprising:
adjusting the reflection threshold value based on the comparison.

14. The method of claim 8, further comprising:
determining an identity of the object obstructing the air curtain based on a magnitude of difference between reflections detected by the sensor and the reflection threshold value.

15. A non-transitory machine readable medium storing instructions executable by a processing device, wherein execution of the instructions causes the processing device to implement a method for detecting motion, the method comprising:
generating an air curtain via an air flow source;
rotating a rotatable airfoil located at least partially downstream of the air flow source, wherein the airfoil contains an RF reflective material;
detecting RF reflections from the airfoil using a sensor;
comparing reflections detected by the sensor against a reflection threshold value;
determining that an object has obstructed the air curtain in response to reflections detected by the sensor decreasing below the reflection threshold value;
computing a number of objects passing through the air curtain during a specified period of time in response to reflections detected by the sensor decreasing below the reflection threshold value; and
comparing the number computed against traffic data collected from a computing terminal.

16. The non-transitory machine readable medium of claim 15, wherein execution of the instructions further causes the processing device to compute a size of the object obstructing the air curtain based on a magnitude of difference between reflections detected by the sensor and the reflection threshold value.

17. The non-transitory machine readable medium of claim 15, wherein execution of the instructions further causes the processing device to compute a number of objects obstructing the air curtain based on a magnitude of difference between reflections detected by the sensor and the reflection threshold value.

18. The non-transitory machine readable medium of claim 15, wherein execution of the instructions further causes the processing device to continuously scan, via the sensor, for RF energy reflected from the airfoil.

19. The non-transitory machine readable medium of claim 15, wherein execution of the instructions further causes the processing device to adjust the threshold value based on the comparison.

20. The non-transitory machine readable medium of claim 15, wherein execution of the instructions further causes the processing device to determine an identity of the object obstructing the air curtain based on a magnitude of difference between reflections detected by the sensor and the reflection threshold value.
